(19) United States
(12) Patent Application Publication
(10) Pub. No.: US 2010/0113005 A1
(43) Pub. Date: May 6, 2010

(54) METHODS AND APPARATUS FOR MOBILE UNITS WITH LOCAL ACTION AND REMEDIATION

(75) Inventors: Allan Herrod, Mission Viejo, CA (US); Paul Cowan, Humble, TX (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 12/263,265

(22) Filed: Oct. 31, 2008

(51) Int. Cl. H04W 24/00

(52) U.S. Cl. 455/423

(57) ABSTRACT

A remediation system employs local and autonomous conditions within the mobile unit itself. A method for performing remediation for a plurality of mobile units generally includes determining a first set of remediations, wherein each remediation includes a condition for determining whether a remediation is necessary for one of the mobile units, and an action for addressing the condition. The system may determine a second set of remediations, and providing the second set of remediations to the mobile units.

### TECHNICAL FIELD

The present invention generally relates to mobile units such as mobile computing devices, cellular phones, personal data assistants (PDAs), and the like, and more particularly relates to provisioning and remediation of such devices.

### BACKGROUND

In recent years the use of cellular phones, smart phones, global positioning systems (GPS), personal data assistants (PDAs), laptop computers, and other such mobile units has increased dramatically. In any given enterprise, it is not uncommon for many thousands of mobile units to be present within the system. It is therefore a difficult but critical task to administer large groups of mobile units, particularly when their use is important to day-to-day operation of the enterprise.

One administrative task relates to remediation—i.e., diagnosing and addressing errors or deficiencies in the software and/or hardware of the mobile unit. Presently known remediation schemes are unsatisfactory in a number of respects. For example, many remediation systems limit remediation to specific domains (particular vendors), a fixed set of remediations that are built in to the unit, and/or a fixed set of applicable mobile units.

Furthermore, such remediation is either initiated by a central server or the mobile unit itself, not by both. Accordingly, in some instances, where all remediation is performed by a central server, if connectivity to the mobile unit fails, remediation becomes impossible. On the other hand, when all of the remediation is performed by the mobile unit, centralized control and remediation across and enterprise becomes difficult.

Accordingly, it is desirable to provide improved systems and methods for remediation of mobile units in an enterprise. Furthermore, other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a mobile unit remediation system in accordance with an exemplary embodiment of the present invention;

FIG. 2 is a conceptual block diagram of data structures in accordance with an exemplary embodiment of the present invention.

### DETAILED DESCRIPTION

The present invention generally relates to highly-customizable and extensible remediation of mobile units (e.g., resolution of errors or deficiencies) in a manner that is at least partially local to the mobile units themselves. In this regard, the following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, wireless networks, cellular networks, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

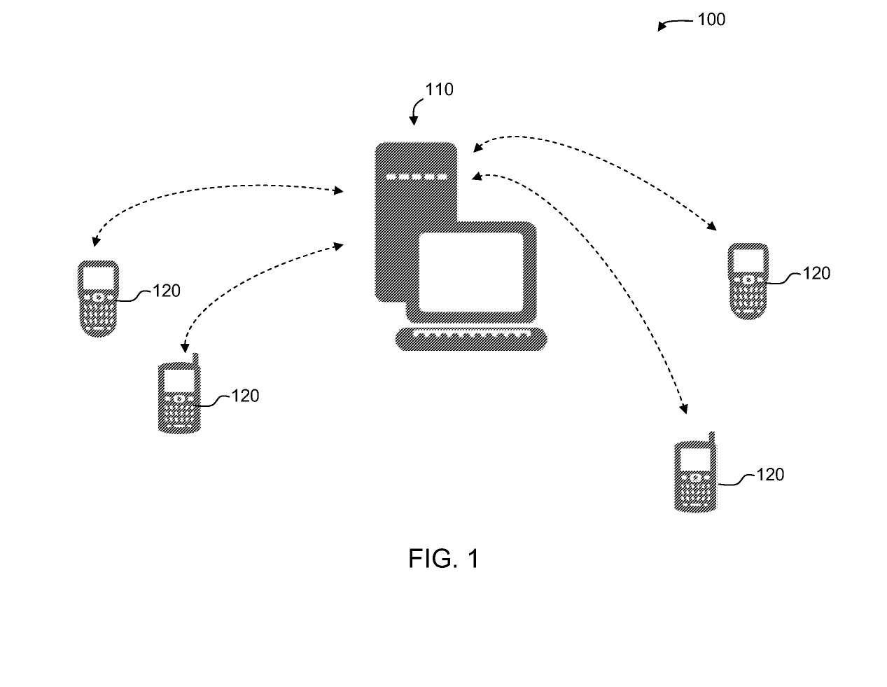

Referring now to FIG. 1, a remediation system 100 in accordance with the present invention generally operates within the context of a control server 110 configured to communicate wirelessly or through a wired connection (using one or more intermediate switches, routers, relays, access points, or the like) with a plurality of mobile units 120. Remediation of the various mobile units is accomplished through a combination of autonomous and self contained local action (i.e., within the respective mobile units 120 themselves) and remote action (from control server 110) in accordance with respective sets of configurable conditions and actions provided within control server 110 and mobile units 120. Local action in this context refers to action that takes place at the sole discretion of the mobile unit and solely using information already possessed by the mobile unit.

Although not illustrated, it will be understood that each mobile unit 120 generally includes one or more processors (e.g., microprocessor or microcontroller), one or more storage components (e.g., RAM, ROM, disk storage, etc.), a user interface 102, and an I/O module, all suitably interconnected via a bus or other connection means. The processor is configured to carry out software and/or firmware instructions stored within the storage component, in the conventional manner, while interfacing with the user interface and I/O module. Depending upon the type of mobile unit, the user interface may include any combination of hardware and software components configured to provide an interface with a human user, including, but not limited to, touch screens (e.g., capacitive and resistive screens), keyboards, buttons, dials, displays (e.g., LCDs, LEDs, etc.), and the like.

Mobile units 120 may be configured to communicate via WiFi (IEEE 802.11), IrDA (infrared), Bluetooth, ZigBee (and other variants of the IEEE 802.15 protocol), IEEE 802.16 (WiMAX or any other variation), Direct Sequence Spread Spectrum, Frequency Hopping Spread Spectrum, cellular/wireless/cordless telecommunication protocols (e.g., 3G), wireless home network communication protocols, paging network protocols, GPS, magnetic induction, satellite data communication protocols, wireless hospital or health care facility network protocols such as those operating in the WMTS bands, GPRS, and proprietary wireless data communication protocols such as variants of Wireless USB.

Mobile units 120 may take a variety of forms and have any desired physical dimensions. For example, mobile units 120 may be a cellular phone, PDA, an RFID reader, or the like, or may be a conventional laptop, sub-notebook, or netbook.

Control server (or simply “server”) 110 includes any combination of hardware and software capable of carrying out the functions described herein. In that regard, server 110 may also include various networking components, databases, consoles, etc., which, for the sake of clarity, are not illustrated in the figures. In one embodiment, for example, server 110 corresponds to one of the various Mobility Service Platform (MSP) servers provided by Motorola, Inc.

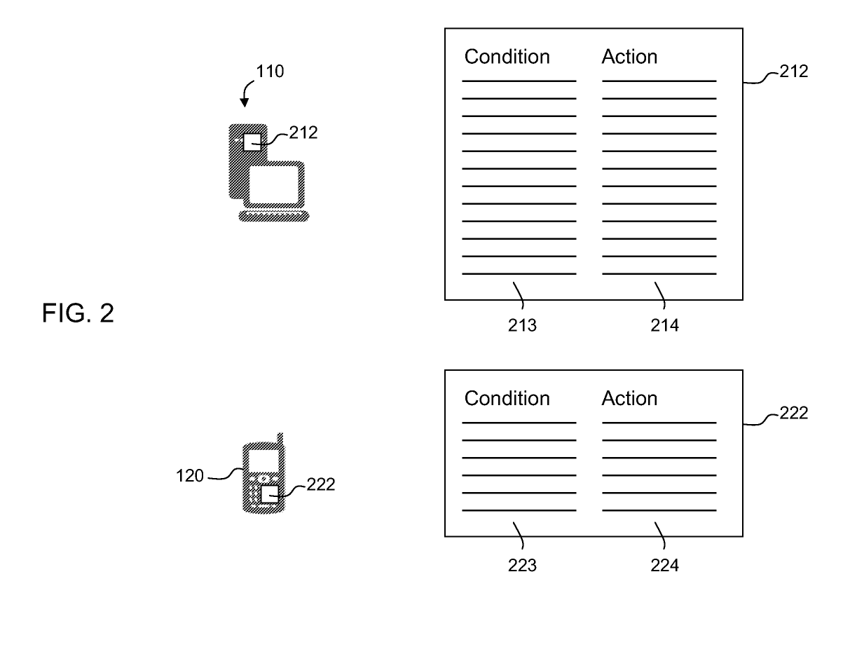

In accordance with one embodiment, remediation is performed by a combination of local remediation and remote remediation. Thus, referring to FIG. 2, server 110 includes a remediation table or database 212 including a set of conditions 213 having corresponding actions (e.g., actions designed to remediate the state represented by the conditions) 214. A subset of the entries within table 212 are considered to be the type of remedies that should be initiated autonomously by the mobile unit, and are therefore transmitted and stored on mobile unit 120 within table a local remediation table 222, which includes a set of conditions 223 and corresponding actions 224 that can be performed by mobile unit 120 itself. As used herein, the term “remediation” means correcting, altering, or otherwise addressing some error or deficiency associated with a particular mobile unit 120.

A “condition” as used herein is a definition of how to detect the circumstances requiring remediation. In one embodiment, multiple conditions may be combined using logical ANDs and ORs to form a complex conditions.

The types of conditions/actions advantageously stored locally within table 222 include, for example, those conditions in which connectivity to server 110 fails or is poor. The most common case includes correcting a situation where the configuration of one or more subsystems that affect connectivity to control server 110 are unintentionally or deliberately changed. In such a case, successful remediation requires that the change (or its effect) be detected and then reversed by reapplying the original correct configuration. Another case is where a problem with the network or server causes loss of connectivity. In such a case, the original configuration remains in effect but does not achieve the desired result. Successful remediation might require that an alternate configuration be applied temporarily. At some later time, the original configuration may also need to be re-applied when the primary connection is again working.

The respective lists of conditions and actions within tables 212 and 222 are preferably configured by the administrator through server 110 (e.g., via a standard console). Conditions 213 and 223 may be arbitrarily complex and configurable to allow for a wide range of remediation scenarios.

It should be appreciated that the example embodiment or embodiments described herein are not intended to limit the scope, applicability, or configuration of the invention in any way. For example, these methods may be used in connection with standard barcode readers and the like. In general, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for performing remediation for a plurality of mobile units, the method comprising:
determining a first set of remediations, each remediation comprising a condition for determining whether a remediation is necessary for one of the mobile units, and an action for addressing the condition;
determining a second set of remediations; and
providing the second set of remediations to the mobile units.

2. The method of claim 1, wherein the second set of remediations comprises a subset of the first set of remediations.

3. The method of claim 1, further comprising transmitting the second set of remediations to the mobile units over a network.

4. The method of claim 3, wherein the network is a wireless network.

5. The method of claim 1, further comprising:
determining, within a first mobile unit, that a first condition within the second set of remediations has occurred; and
performing a first action associated with the first condition within the second set of remediations.

6. The method of claim 1, further comprising:
interrogating a first mobile unit to determine whether a first condition within the first set of remediations, but not within the second set of remediations, has occurred;
remotely instructing the first mobile unit to perform a first action associated with the first condition.

7. The method of claim 1, further including sending a confirmation that a remediation has been successfully performed.

8. The method of claim 1, wherein the first set of remediations are associated with a mobile communications device.

9. The method of claim 1, wherein the first set of remediations are associated with a mobile computing device.

10. A method for managing remediation of a plurality of mobile units, comprising:
providing a set of remediations;
partitioning the set of remediations into local remediations and remote remediations;
providing the local remediations within the mobile units;
providing the remote remediations within a server physically separated from the mobile units;
remediating a state detected when a condition at the mobile units is met based on the set of remediations.

11. The method of claim 10, wherein the local remediations are transmitted to the mobile units via a network.

12. The method of claim 10, wherein the set of remediations are associated with a mobile telephone device.

13. The method of claim 10, wherein each remediation comprises a condition and an action.

14. The method of claim 13, where each condition and each action is configurable by a user.

15. A mobile unit management system comprising:
a central server having a first set of remediations stored therein;
a mobile unit having a second set of remediations stored therein;
wherein each of the first and second set of remediations includes a configurable condition and a configurable action; and
wherein, when a particular configurable action is experienced by the mobile unit, a remediation is applied autonomously and locally within the mobile unit based on whether the particular configurable action is within the second set of remediations.

16. The mobile unit management system of claim 15, wherein the second set of remediations is a subset of the first set of remediations.

17. The mobile unit management system of claim 15, wherein the configurable condition comprises Boolean combinations of other conditions.

18. The mobile unit management system of claim 15, wherein the mobile unit is configured to send a confirmation message to the central server indicative of the success of the remediation.
